(19) United States
(12) Patent Application Publication
(10) Pub. No.: US 2015/0127796 A1
(43) Pub. Date: May 7, 2015

(54) METHOD OF MANAGING RESOURCE TRANSMISSION BETWEEN TWO SERVICE PROVIDERS AND RELATED COMPUTER SYSTEM

(71) Applicant: Synology Incorporated, Taipei (TW)

(72) Inventors: Shi-Shiuan Kao, Taipei City (TW); Chih-Kuang Huang, Kaohsiung City (TW); Jen-Wei Kuo, New Taipei City (TW)

(73) Assignee: Synology Incorporated, Taipei (TW)

(21) Appl. No.: 14/259,170

(22) Filed: Apr. 23, 2014

(30) Foreign Application Priority Data
Nov. 1, 2013 (TW) 102139836

(51) Int. Cl. H04L 12/911

(52) U.S. Cl. CPC H04L 47/78
USPC 709/223

(57) ABSTRACT

When performing resource management between different service providers, a first interface and a second interface are provided simultaneously on an electronic device for connecting to a first service provider and a second service provider, respectively. The first interface is arranged to display the resource list of the first service provider as icons, and the second interface is arranged to display the resource list of the second service provider as icons. When a specific icon on one of the interfaces is selected and then dragged to the other interface, resource transmission between the first and second service providers may be activated.

### BACKGROUND OF THE INVENTION

1. Field of the Invention

The present invention is related to a method of managing resource transmission and related computer system, and more particularly, to a method of managing resource transmission between two service providers and related computer system.

2. Description of the Prior Art

In order to access the resources provided by a specific service provider, the user may open an interface using an electronic device for connecting to the web page of the specific service provider. The interface is arranged to display the resource list of the specific service provider as one or multiple icons. Each icon is representative of a file, a folder or an application program provided by the specific service provider. The user may then select a specific icon on the interface for accessing the corresponding resource.

In the prior art, when the user intends to transmit resources between a first service provider and a second service provider, an interface is first opened using an electronic device for connecting to the web page of the first service provider. Next, the interface is used for browsing the resource list of the second service provider, and a resource provided by the second service provider can then be transmitted to the first service provider via the electronic device. However, the prior method does not provide an instinctive operation to access the resource lists of different service providers. The transmission of resources between different service providers using the prior method takes a long time, during which the bandwidth of the electronic device is also occupied.

### SUMMARY OF THE INVENTION

The present invention provides a method of managing resource transmission between two service providers. The method includes providing a first interface for managing a first service provider which is configured to provide a specific resource; providing a second interface for managing a second service provider; simultaneously displaying the first interface and the second interface on a screen of an electronic device; displaying an icon representative of the specific resource on the first interface; the second interface accessing an attribute of the icon when detecting that the icon has been dragged from the first interface to the second interface; the second interface transmitting the attribute of the icon to the second service provider; the second service provider sending a transmission request to the first service provider when determining that the attribute of the icon matches a format of the second service provider; and transmitting the specific resource from the first service provider to the second service provider.

The present invention also provides a computer system for managing resource transmission between two service providers. The computer system includes a first service provider configured to send a transmission request when determining that an attribute of an icon matches a format of the first service provider; a second service provider configured to provide a specific resource and transmit the specific resource to the first service provider after receiving the transmission request; and an electronic device. The electronic device is configured to provide a first interface for managing the first service provider; provide a second interface for managing the second service provider; simultaneously display the first interface and the second interface on a screen; display the icon representative of the specific resource on the second interface; access the attribute of the icon using the first interface when detecting that the icon has been dragged from the second interface to the first interface; and transmit the attribute of the icon to the first service provider.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a computer system for managing resources between two service providers according to the present invention.

FIG. 2 is a flowchart illustrating the operation of the computer system when managing resources between two service providers according to the present invention.

### DETAILED DESCRIPTION

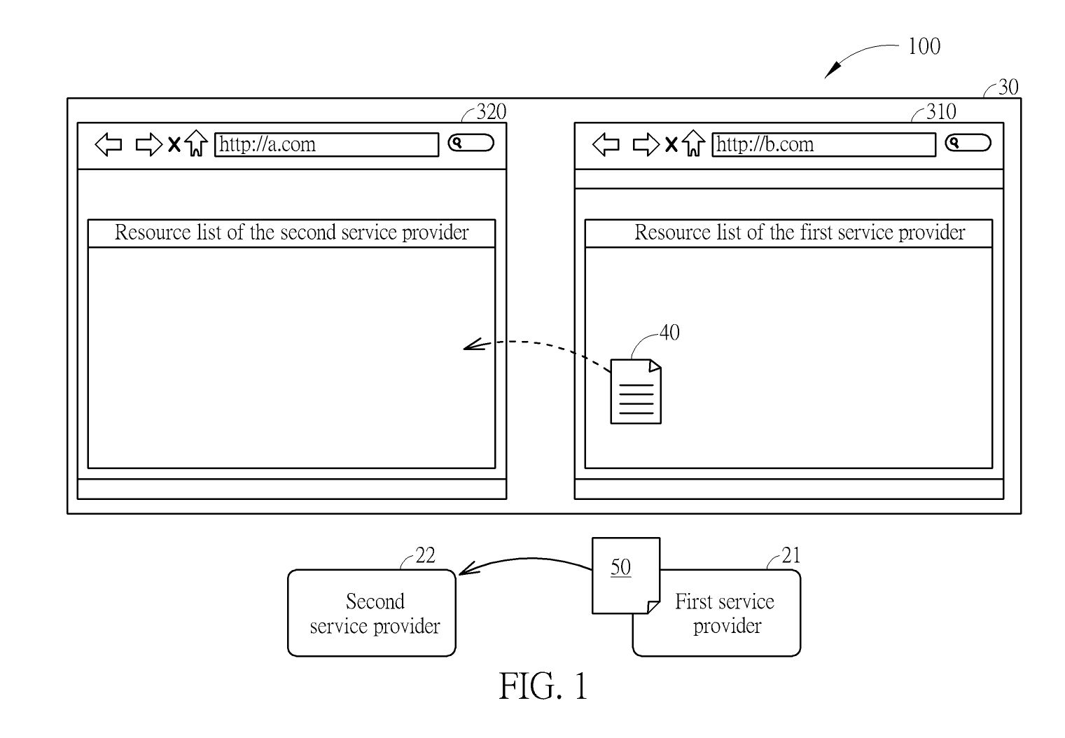

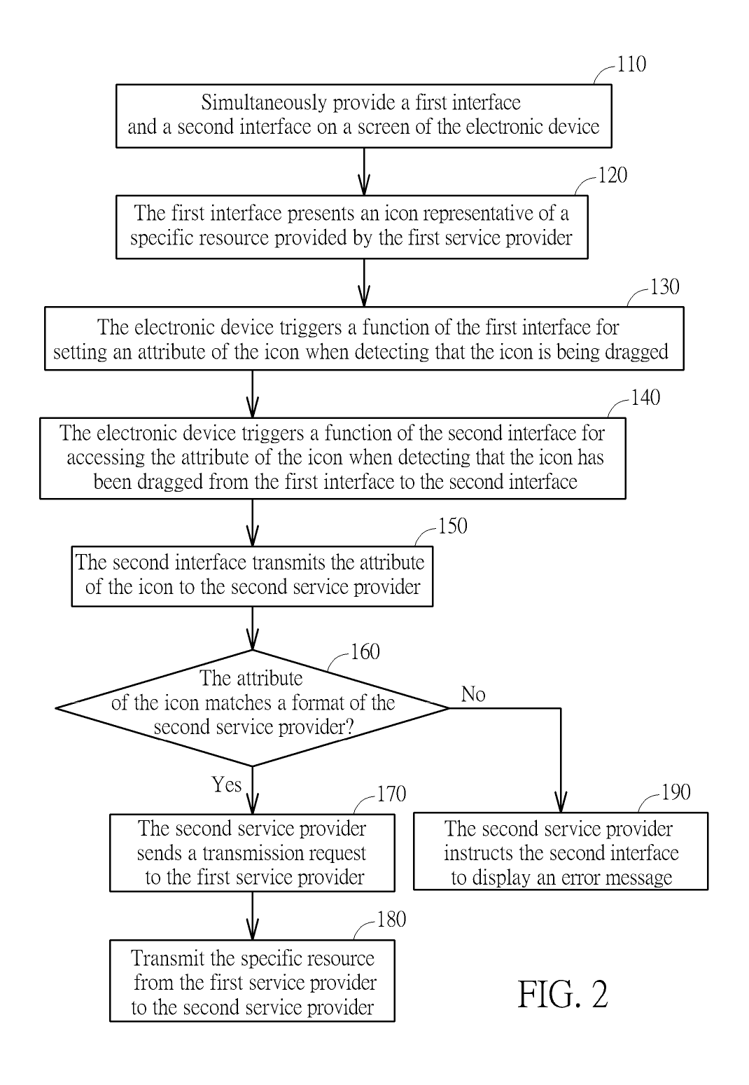

FIG. 1 is a diagram illustrating a computer system 100 for managing resources between two service providers according to the present invention. FIG. 2 is a flowchart illustrating the operation of the computer system 100 when managing resources between two service providers according to the present invention. The computer system 100 includes a first service provider 21, a second service provider 22, and an electronic device 30 configured to execute the following steps depicted in FIG. 2.

Step 110: simultaneously provide a first interface 310 and a second interface 320 on a screen of the electronic device 30; execute step 120.

Step 120: the first interface 310 presents an icon 40 representative of a specific resource 50 provided by the first service provider 21; execute step 130.

Step 130: the electronic device 30 triggers a function of the first interface 310 for setting an attribute of the icon 40 when detecting that the icon 40 is being dragged; execute step 140.

Step 140: the electronic device 30 triggers a function of the second interface 320 for accessing the attribute of the icon 40 when detecting that the icon 40 has been dragged from the first interface 310 to the second interface 320; execute step 150.

Step 150: the second interface 320 transmits the attribute of the icon 40 to the second service provider 22; execute step 160.

Step 160: the second service provider 22 determines whether the attribute of the icon 40 matches a format of the second service provider 22; if yes, execute step 170; if no, execute step 190.

Step 170: the second service provider 22 sends a transmission request to the first service provider 21; execute step 180.

Step 180: transmit the specific resource 50 from the first service provider 21 to the second service provider 22.

Step 190: the second service provider 22 instructs the second interface 22 to display an error message.

In the computer system 100 according to the present invention, the first service provider 21 and the second service provider 22 may be servers with different functions, such mail servers, web servers or file servers. The first service provider 21 and the second service provider 22 may also be servers implemented in different structures, such blade servers, rack servers or pedestal servers. The electronic device 30 may be a personal computer, a notebook computer or a mobile device including, but not limited to, a tablet computer, a smartphone or a personal digital assistant (PDA). The screen of the electronic device 30 may adopt a touch panel or another type of screen without touch functions. However, the types and structures of the first service provider 21, the second service provider 22 and the electronic device 30 do not limit the scope of the present invention.

In step 110, the electronic device 30 is configured to simultaneously provide the first interface 310 and the second interface 320 on its screen. The first interface 310 is used for managing the resources provided by first service provider 21, and the second interface 320 is used for managing the resources provided by second service provider 22. For example, the first interface 310 may acquire a resource list from the first service provider 21 using a HyperText Markup Language (HTML) communication protocol and present the resource list as an HTML web page; the second interface 320 may acquire a resource list from the second service provider 22 using the HTML communication protocol and present the resource list as an HTML web page.

In step 120, the first interface 310 is configured to present the icon 40 representative of the specific resource 50 (one or multiple files, folders or application programs) in the resource list of the first service provider 21. Similarly, although not depicted in FIG. 1, the second interface 320 may display a specific icon representative of a specific resource (one or multiple files, folders or application programs) in the resource list of the second service provider 22.

In another embodiment, the first interface 310 and the second interface 320 may acquire the resource lists from the first service provider 21 and the second service provider 21, respectively, using another type of communication protocol. The first interface 310 and the second interface 320 may acquire the resource lists from the first service provider 21 and the second service provider 21, respectively, using the same type of communication protocol or two communication protocols of different types. However, the type of the communication protocol does not limit the scope of the present invention.

In one embodiment, the electronic device 30 may use the same type of browser to simultaneously open the windows of the first interface 310 and the second interface 320. In another embodiment, the electronic device 30 may use two different types of browsers to simultaneously open the windows of the first interface 310 and the second interface 320, respectively. However, the type of the browser used to provide the first interface 310 or the second interface 320 does not limit the scope of the present invention.

When using the electronic device 30, the user may drag the icon 40 using a mouse, a finger or a stylus. In step 130, the electronic device 30 is configured to trigger the function of the first interface 310 for setting the attribute of the icon 40. In an embodiment of the present invention, the attribute of the icon 40 may contain HTML information including, but not limited to, the file name of the specific resource 50, the access path of the specific resource 50, and the website of the first service provider 21, and the electronic device 30 may trigger the setDATA function of the first interface 310 for setting the attribute of the icon 40. Similarly, although not depicted in FIG. 2, the electronic device 30 may trigger the function of the second interface 320 for setting the attribute of a specific icon when detecting that the specific icon is being dragged.

When intending to transmit the specific resource 50 from the first service provider 21 to the second service provider 22, the user may drag the icon 40 from the first interface 320 to the second interface 320 using a mouse, a finger or a stylus, as depicted by the dotted arrow in FIG. 1. In step 140, the electronic device 30 is configured to trigger the function of the second interface 320 for accessing the attribute of the icon 40, thereby acquiring the HTML information of the icon 40 including, but not limited to, the file name of the specific resource 50, the access path of the specific resource 50, and the website of the first service provider 21. In step 150, the second interface 320 may then transmit the attribute of the icon 40 to the second service provider 22. In an embodiment of the present invention, the electronic device 30 may trigger the getDATA function of the second interface 320 for accessing the attribute of the icon 40.

In step 160, if the second service provider 22 determines that the attribute of the icon 40 does not match its format, step 190 is then executed for instructing the second interface 22 to display the error message (not shown in FIG. 1). The error message may be used to notify the user that the specific resource 50 is not allowed to be transmitted between the first service provider 21 and the second service provider 22. If the second service provider 22 determines that the attribute of the icon 40 matches its format, steps 170 and 180 are then executed.

In step 170, the second service provider 22 is configured to send the transmission request to the first service provider 21. In step 180, the first service provider 21 is configured to transmit the specific resource 50 to the second service provider 22 after receiving the transmission request, as depicted by the solid arrow in FIG. 1.

In the present invention, when the user intends to transmit resources between a first service provider and a second service provider, a first interface and a second interface may be simultaneously opened using an electronic device for connecting to the web pages of the first service provider and the second service provider, respectively. The first interface is arranged to display the resource list of the first service provider as icons, and the second interface is arranged to display the resource list of the second service provider as icons. When a specific icon on one of the interfaces is selected and then dragged to the other interface, direct resource transmission between the first and second service providers maybe conducted without using the electronic device. Therefore, the present invention can provide direct, efficient and instinctive operation for transmitting resources between different service providers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of managing resource transmission between two service providers, comprising:
providing a first interface for managing a first service provider which is configured to provide a specific resource;
providing a second interface for managing a second service provider;
simultaneously displaying the first interface and the second interface on a screen of an electronic device;
displaying an icon representative of the specific resource on the first interface;
the second interface accessing an attribute of the icon when detecting that the icon has been dragged from the first interface to the second interface;
the second interface transmitting the attribute of the icon to the second service provider;
the second service provider sending a transmission request to the first service provider when determining that the attribute of the icon matches a format of the second service provider; and
transmitting the specific resource from the first service provider to the second service provider.

2. The method of claim 1, further comprising:
the first interface acquiring a first resource list from the first service provider using a first communication protocol and presenting the first resource list as a first web page; and
the second interface acquiring a second resource list from the second service provider using a second communication protocol and presenting the second resource list as a second web page.

3. The method of claim 2, wherein each of the first communication protocol and the second communication protocol is a HyperText Markup Language (HTML) communication protocol.

4. The method of claim 1, wherein:
providing the first interface includes opening the first interface on the electronic device using a first browser; and
providing the second interface includes opening the second interface on the electronic device using a second browser.

5. The method of claim 1, wherein the first browser and the second browser are of a same type.

6. The method of claim 1, wherein the attribute of the icon includes a file name of the specific resource, an access path of the specific resource, or a website of the first service provider.

7. The method of claim 1, further comprising:
triggering a function of the first interface for setting the attribute of the icon when detecting that the icon is being dragged.

8. The method of claim 1, further comprising:
triggering a function of the second interface for accessing the attribute of the icon when detecting that the icon is being dragged from the first interface to the second interface.

9. The method of claim 1, wherein the specific resource includes one or more files, folders or application programs provided by the first service provider.

10. The method of claim 1, further comprising:
the second service provider instructing the second interface to display an error message for notifying that the specific resource is not allowed to be transmitted between the first service provider and the second service provider when determining that the attribute of the icon does not match the format of the second service provider.

11. A computer system for managing resource transmission between two service providers, comprising:
a first service provider configured to send a transmission request when determining that an attribute of an icon matches a format of the first service provider;
a second service provider configured to provide a specific resource and transmit the specific resource to the first service provider after receiving the transmission request; and
an electronic device configured to:
provide a first interface for managing the first service provider;
provide a second interface for managing the second service provider;
simultaneously display the first interface and the second interface on a screen;
display the icon representative of the specific resource on the second interface;
access the attribute of the icon using the first interface when detecting that the icon has been dragged from the second interface to the first interface; and
transmit the attribute of the icon to the first service provider.
